(19) United States
(12) Patent Application Publication
(10) Pub. No.: US 2008/0046156 A1
(43) Pub. Date: Feb. 21, 2008

(54) Method for propagating adaptation value in automatic transmission

(75) Inventor: Jin Soo Lee, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/638,835

(22) Filed: Dec. 13, 2006

(30) Foreign Application Priority Data
Aug. 17, 2006 (KR) 10-2006-0077877

(51) Int. Cl. G06F 17/00

(52) U.S. Cl. 701/51

(57) ABSTRACT

Disclosed is a method for propagating an adaptation value in an automatic transmission, comprising the steps of: (a) dividing the entire learning region into a plurality of cells according to a predetermined driving condition; (b) determining whether a learning condition is satisfied; (c) determining, if the learning condition is satisfied, whether an adaptation value has been propagated at the cell that represents a current driving condition; and (d) propagating the adaptation value to the entirety of cells.

### CROSS-REFERENCE TO RELATED APPLICATION

This application claims priority to and the benefit of Korean Patent Application No. 10-2006-0077877 filed in the Korean Intellectual Property Office on Aug. 17, 2006, the entire contents of which are incorporated herein by reference.

### BACKGROUND OF THE INVENTION

(a) Field of the Invention

The present invention relates to an automatic transmission. More particularly, the present invention relates to a method for propagating an adaptation value in an automatic transmission for providing a higher stability of learning control.

(b) Background

Generally, an automatic transmission provides convenient driving by automatically shifting to a target shift speed. The target shift speed is derived from a predetermined shifting pattern based on a vehicle speed and variation of a throttle opening. Operational elements are then controlled according to a hydraulic duty of the target shift speed.

For a conventional automatic transmission, an adaptation value is learned for the entire throttle opening or for the entire vehicle speed and it takes relatively long time to learn the adaptation value. Also, initial shifting shock may be serious when a shifting is performed in a region where the adaptation value has not been learned. In addition, since the adaptation value is hard to be learned at a specific learning condition, it is hard to perform a learning control at the specific learning condition.

To solve such problems, engine designers have studied a learning control method that enhances a learning efficiency.

For example, Korean Patent No. 0488709 discloses a learning control method where a duty ratio is learned based on hydraulic pressure and an amount of overrun occurrence.

However, in such control methods, an adaptation value has to be learned for the entire throttle opening or the entire vehicle speed. Thus, when the shifting is performed in a region where an adaptation value has not been learned, an initial shifting shock may be serious. In addition, it is still hard to learn an adaptation value in a specific learning region.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for propagating an adaptation value in an automatic transmission that can reduce such shift shock.

In addition, the present invention has been made in an effort to provide a method for propagating an adaptation value in an automatic transmission that can shorten a period of time required to complete the learning of an adaptation value.

According to an exemplary embodiment of the present invention, the entire learning region is divided into cells according to a predetermined condition. An adaptation value is learned at one cell that represents a specific learning region. Such adaptation value is propagated to the entirety of cells in the automatic transmission.

In one aspect, the present invention provides a method for propagating an adaptation value in an automatic transmission, comprising the steps of: (a) dividing the entire learning region into a plurality of cells according to a predetermined driving condition; (b) determining whether a learning condition is satisfied; (c) determining, if the learning condition is satisfied, whether an adaptation value has been propagated at the cell that represents a current driving condition; and (d) propagating the adaptation value to the entirety of cells.

The learning condition may be satisfied when a vehicle speed is within a predetermined range based on a predetermined shifting pattern in a power-on state.

The cells may be divided according to an oil temperature of the automatic transmission.

The propagation of the adaptation value may occur in the order of from the smallest value of the difference between the oil temperatures in the cells to the largest value.

In addition, the cells may be divided according to the vehicle speed based on the predetermined shifting pattern.

In a preferred embodiment, the present method may further comprise the step of calculating the adaptation value when an adaptation value has not occurred at the cell that represents a current driving condition.

Preferably, the calculation may be performed by calculating a limit time based on a vehicle speed and a turbine torque and determining a modification value of control duty based on the limit time.

In another preferred embodiment, such methods may further comprise the step of determining whether the number of learning times of the cell that represents a current driving condition is higher than or equal to a predetermined number of learning times.

In such embodiment, when the number of learning times is higher than or equal to the predetermined number of learning times, the adaptation value of the cell is propagated to the entirety of cells.

Preferably, the value propagated to the entirety of cells may be obtained by multiplying the adaptation value by a predetermined weight value.

Also preferably, the propagation value may be forcibly stored in the entirety of cells.

Suitably, the weight value may be smaller than or equal to 1. More suitably, the weight value may be 0.7 at the entirety of cells.

The weight values of the respective cells may be different from each other.

### BRIEF DESCRIPTION OF THE DRAWINGS

FIG. 1 is a block diagram of a system for operating a method for propagating an adaptation value in an automatic transmission according to an exemplary embodiment of the present invention.

FIG. 2 is a flowchart of an exemplary method for propagating an adaptation value in an automatic transmission according to an embodiment of the present invention.

FIG. 3 is a graph showing a time limit related to a turbine torque and a vehicle speed.

Reference numerals set forth in the Drawings includes reference to the following elements as further discussed below:

| | |
|---|---|
| 10: throttle opening detector | 20: vehicle speed detector |
| 30: turbine speed detector | 40: oil temperature detector |
| 50: air flow detector | 60: transmission control unit |
| 70: ram | 80: actuator |
| 90: automatic transmission | |

### DETAILED DESCRIPTION

Exemplary embodiments of the present invention will hereinafter be described in detail with reference to the accompanying drawings.

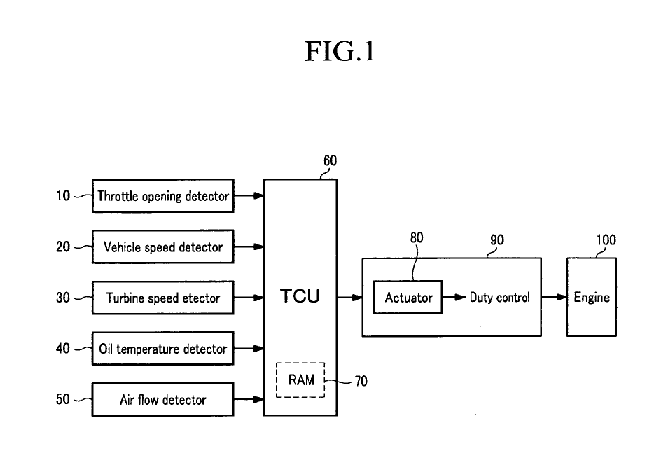

FIG. 1 is a block diagram of a system for operating a method for propagating an adaptation value in an automatic transmission according to an exemplary embodiment of the present invention.

As shown in FIG. 1, an exemplary system for operating a method according to the present invention propagates the adaptation value in the automatic transmission 90 connected to an engine 100.

The exemplary system may include a throttle opening detector 10, a vehicle speed detector 20, a turbine speed detector 30, an oil temperature detector 40, an air flow detector 50, a transmission control unit 60, and an actuator 80.

The throttle opening detector 10 detects a throttle opening of a throttle valve operated in accordance with an operation of an acceleration pedal and transmits a signal to the transmission control unit 60.

The vehicle speed detector 20 detects a vehicle speed and transmits a signal to the transmission control unit 60.

The turbine speed detector 30 detects a turbine speed operating as an input torque of the transmission by detecting change of crank shaft angle and transmits a signal to the transmission control unit 60.

The oil temperature detector 40 detects an oil temperature in the transmission and transmits a signal to the transmission control unit 60.

The air flow detector 50 detects an intake air amount and transmits a signal to the transmission control unit 60.

The transmission control unit 60 can be realized by one or more processors activated by a predetermined program, and the predetermined program can be programmed to perform each step of a method according to an embodiment of this invention.

The transmission control unit 60 generates a signal for controlling the automatic transmission 90 based on the signals received from the throttle opening detector 10, the vehicle speed detector 20, the turbine speed detector 30, the oil temperature detector 40, and the air flow detector 50.

In addition, the entire learning region is divided into a plurality of cells according to a predetermined condition, and the cells are stored in a ram 70 of the transmission control unit 60. Each cell represents a specific learning region and stores the adaptation value learned at each specific learning region. In addition, each cell stores the number of learning times. It also stores the information on whether a propagation of the adaptation value occurs. The number of learning times means the number of times by which learning of the adaptation value occurs at each cell.

Although, the cells may be divided according to a vehicle speed based on a predetermined shifting pattern, according to an exemplary embodiment of the present invention, the cells are divided according to an oil temperature since viscosity of oil can vary according to the oil temperature.

The actuator 80 receives the signal from the transmission control unit 60 and controls the automatic transmission 90.

The actuator 80 may, not limited to, be a solenoid valve that controls a hydraulic pressure in the automatic transmission 90.

The present invention, as discussed above, provides a method for propagating an adaptation value in an automatic transmission, comprising the steps of: (a) dividing the entire learning region into a plurality of cells according to a predetermined driving condition; (b) determining whether a learning condition is satisfied; (c) determining, if the learning condition is satisfied, whether an adaptation value has been propagated at the cell that represents a current driving condition; and (d) propagating the adaptation value to the entirety of cells.

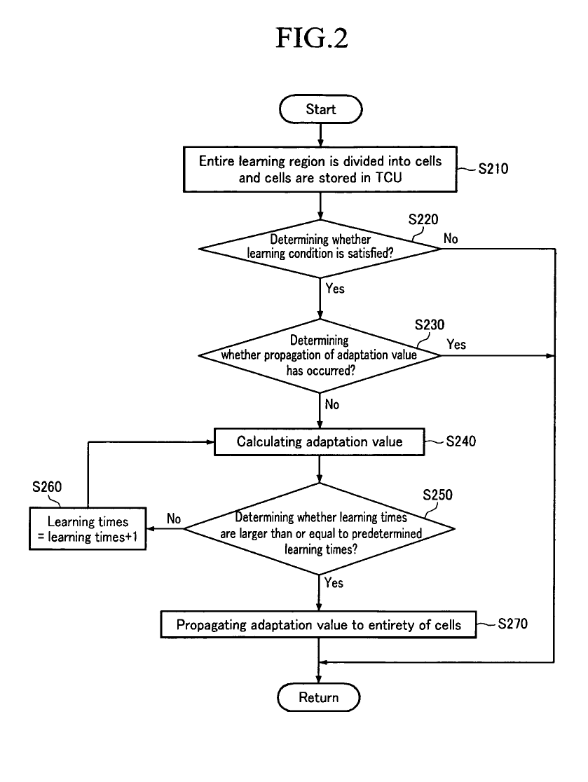

Hereinafter, referring to FIG. 2, an exemplary method for propagating an adaptation value in an automatic transmission according to an embodiment of the present invention will be described in detail.

FIG. 2 is a flowchart of an exemplary method for propagating an adaptation value in an automatic transmission according to an embodiment of the present invention.

As shown in FIG. 2, the entire learning region is divided into cells in accordance with the predetermined condition, and the cells are stored in the ram 70 of the transmission control unit 60 at a step S210. That is, the entire learning region is divided into a plurality of cells according to the oil temperature, and each cell represents a specific oil temperature. Alternatively, the cells may be divided according to the vehicle speed based on the predetermined shifting pattern.

Each cell stores the information on whether the propagation of the adaptation value occurs. It also stores the information of the number of learning times and the adaptation value.

First of all, the transmission control unit 60 determines whether a driving (running) condition of a vehicle satisfies a learning condition at a step S220.

The learning condition is satisfied when the vehicle speed is within a predetermined range of vehicle speed based on the predetermined shifting pattern in a power-on state. In addition, when a shifting is in progress or at least one of the detectors 10, 20, 30, 40, and 50 is out of order, learning the adaptation value is prohibited. In addition, when a vehicle runs in sports mode, hold mode, or low range mode, learning the adaptation value is also prohibited.

If the learning condition is not satisfied, propagating process will stop here.

On the other hand, if the learning condition is satisfied, the transmission control unit 60 determines whether the propagation of the adaptation value has occurred at the cell that represents a current driving state, at a step S230.

If the propagation of the adaptation value has occurred at the cell, propagating process will stop here.

If the propagation of the adaptation value has not occurred at the cell, the transmission control unit 60 calculates the adaptation value at a step S240.

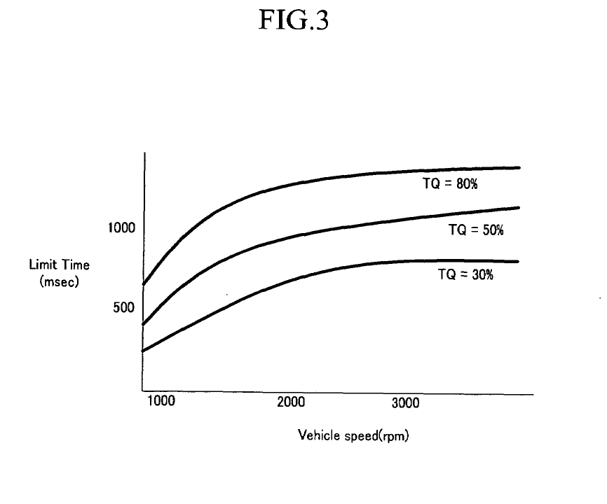

The calculation of the adaptation value can be performed by any method known in the art. As shown in FIG. 3, according to an exemplary method for calculating the adaptation value, a limit time is calculated based on the vehicle speed and the turbine torque, and a modification value of the control duty is calculated in accordance with the limit time. Based on this, the adaptation value is calculated. Such a method is known to a person of an ordinary skill in the art, and will not be described in further detail.

Thereafter, the transmission control unit 60 compares the number of learning times with a predetermined number of learning times at a step S250. As the adaptation value learned at an early stage may not be a suitable adaptation value, it may be repetitively learned by a predetermined number of learning times such that a variation between each adaptation value can be small. After that, the adaptation value is propagated to the entirety of cells. The predetermined number of learning times may be easily obtained by a person of an ordinary skill in the art. For example, the predetermined number of learning times may be 3.

If the number of learning times of the cell is smaller than the predetermined number of learning times, the number of learning times is added by 1 and stored in the cell at a step S260. After that, the adaptation value of the cell is calculated again at the step S240.

If the number of learning times of the cell is greater than or equal to the predetermined number of learning times, the adaptation value is propagated to the entirety of cells at a step S270. In particular, a propagation value is calculated by multiplying the adaptation value by a weight value, and the propagation value is forcibly stored in the entirety of cells that represent the entire learning region. When the adaptation value is propagated, the propagation value is forcibly stored in the entirety of cells that represent the entire learning region and the shifting is controlled according to the propagation value at each running state. If the adaptation value is stored in the entirety of cells, the adaptation value may be larger than a target duty ratio that is needed at a specific running state. In such case, an initial shifting shock may occur by the propagation of the adaptation value. Therefore, the weight value may be smaller than or equal to 1 so as to reduce the initial shifting shock.

If desired, the weight value of the respect cells may be different from each other so as to improve a learning efficiency.

The weight value also may be easily obtained by a person of an ordinary skill in the art. For example, the weight value may be 0.7 at the entirety of cells.

In addition, the adaptation value may be propagated according to a distribution of the oil temperature. For example, the propagation of the adaptation value may occur in the order of from the smallest value of the difference between the oil temperatures in the cells to the largest value. More particularly, the adaptation value is firstly propagated to the cell that represents the oil temperature closest to the oil temperature of the cell where the learning of the adaptation value has occurred. It is then finally propagated to the cell that represents the oil temperature farthest from the oil temperature of the cell where the learning of the adaptation value has occurred.

As described above, the present invention reduce a time required to complete the learning of the adaptation value at the entirety of cells and prevent initial shifting shock by propagating the adaptation value learned at a specific cell to the entirety of cells.

In addition, the present invention also improves stability of learning control by multiplying the adaptation value by a weight value smaller than or equal to 1 and then propagating it to the entirety of cells.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for propagating an adaptation value in an automatic transmission, comprising the steps of:
(a) dividing the entire learning region into a plurality of cells according to a predetermined driving condition;
(b) determining whether a learning condition is satisfied;
(c) determining, if the learning condition is satisfied, whether an adaptation value has been propagated at the cell that represents a current driving condition; and
(d) propagating the adaptation value to the entirety of cells.

2. The method of claim 1, wherein the cells are divided according to an oil temperature of the automatic transmission.

3. The method of claim 2, wherein the propagation of the adaptation value occurs in the order of from the smallest value of the difference between the oil temperatures in the cells to the largest value.

4. The method of claim 1, wherein the cells are divided according to the vehicle speed based on a predetermined shifting pattern.

5. The method of claim 1, wherein the learning condition is satisfied when a vehicle speed is within a predetermined range based on a predetermined shifting pattern in a power-on state.

6. The method of claim 1, further comprising the step of calculating the adaptation value when an adaptation value has not occurred at the cell that represents a current driving condition.

7. The method of claim 6, wherein the propagation of the adaptation value occurs after the adaptation value is repetitively calculated by a predetermined number of times.

8. The method of claim 6, the calculation is performed by calculating a limit time based on a vehicle speed and a turbine torque and determining a modification value of control duty based on the limit time.

9. The method of claim 6, further comprising the step of determining whether the number of learning times of the cell that represents a current driving condition is higher than or equal to a predetermined number of learning times.

10. The method of claim 9, wherein, when the number of learning times is higher than or equal to the predetermined number of learning times, the adaptation value of the cell is propagated to the entirety of cells.

11. The method of claim 10, wherein the value propagated to the entirety of cells is obtained by multiplying the adaptation value by a predetermined weight value.

12. The method of claim 11, wherein the propagation value is forcibly stored in the entirety of cells.

13. The method of claim 11, wherein the weight value is smaller than or equal to 1.

14. The method of claim 12, wherein the weight value is 0.7 at the entirety of cells.

15. The method of claim 11, wherein the weight values of the respective cells are different from each other
